(19) United States
(12) Patent Application Publication
(10) Pub. No.: US 2026/0288244 A1
(43) Pub. Date: Sep. 24, 2026

(54) Measurement of Facial Muscle EMG Potentials for Predictive Analysis Using a Smart Wearable System and Method

(71) Applicant: BRAGI GmbH, München (DE)

(72) Inventors: Julius Friedrich Rüdiger, München (DE); Peter Vincent Boesen, München (DE)

(73) Assignee: BRAGI GmbH, München (DE)

(21) Appl. No.: 19/694,654

(22) Filed: Jun. 1, 2026

Related U.S. Application Data
(63) Continuation of application No. 18/774,910, filed on Jul. 16, 2024, now Pat. No. 12,675,163.
Application No. 18/774,910 is a continuation of application No. 18/322,993, filed on May 24, 2023, now Pat. No. 12,045,390.
Application No. 18/322,993 is a continuation of application No. 17/700,248, filed on Mar. 21, 2022, now Pat. No. 11,675,437.
Application No. 17/700,248 is a continuation of application No. 17/102,864, filed on Nov. 24, 2020, now Pat. No. 11,294,466.
Application No. 17/102,864 is a continuation of application No. 15/703,811, filed on Sep. 13, 2017, now Pat. No. 10,852,829.
(60) Provisional application No. 62/393,926, filed on Sep. 13, 2016.

(51) Int. Cl. G06F 3/01; G06F 1/16; H04R 1/10; H04R 5/033

(52) U.S. Cl. CPC G06F 3/015; G06F 1/163; G06F 1/1694; G06F 3/017; H04R 1/1016; H04R 1/1041; G06F 2200/1637; H04R 5/033; H04R 2420/07; H04R 2460/13

(57) ABSTRACT

A system includes at least one wearable device having a housing, at least one sensor disposed within the housing, at least one output device disposed within the housing, and at least one processor operatively connected to the sensors and output devices, wherein one or more sensors are configured to detect electrical activity from a user’s facial muscles and to transmit a data signal concerning the electrical activity of the user’s facial muscles to one of more of the processors. A method of controlling a wearable device includes determining facial muscular electrical data of a facial gesture made by a user, interpreting the facial muscular electrical data to determine a user response, and performing an action based on the user response.

### PRIORITY STATEMENT

This application is a continuation of U.S. Non-provisional Patent Application 18/774,910, filed on July 16, 2024 which is a continuation of U.S. Non-provisional Patent Application 18/322,993, filed on May 24, 2023 now patented as 12,045,390 which is a continuation of U.S. Non-provisional Patent Application 17/700,248, filed on March 21, 2022 now patented as 11,675,437 which is a continuation of U.S. Non-provisional Patent Application 17/102,864, filed on November 24, 2020 now patented as 11,294,466 which is a continuation of U.S. Non-provisional Patent Application 15/703,811, filed on September 13, 2017 now patented as 10,852,829 and claims priority to U.S. Provisional Patent Application 62/393,926, filed on September 13, 2016, and all entitled “Measurement of Facial Muscle EMG Potentials for Predictive Analysis Using a Smart Wearable System and Method”, hereby incorporated by reference in their entireties.

### FIELD OF THE INVENTION

The present invention relates to wearable devices. More particularly, but not exclusively, the present invention relates to wearable devices that may be modified by facial gestures.

### BACKGROUND

Gestural based control systems have their limitations. Precision spatial location is essential for the proper determination of the gestural command. If the position of the measured segment of the body is not in optimal location, errors may occur. Given these issues, what is needed are improved methods, apparatus, and systems for wireless control systems based on gestures.

### SUMMARY

According to one aspect, electromyogram (EMG) technology is used to measure the electrical activity of a user’s facial muscles. Most people are able to control their facial muscles to such a degree as to permit monitoring by an electronic sensor in order to control a wearable device. In addition, the electrical activity of the muscles of the head and neck region may also be measured to provide additional levels of control to the wearable device. Data collected may be used to provide improved gesture control. Data collected may be combined with data from inertial sensors.

Therefore, it is a primary object, feature, or advantage to improve over the state of the art.

It is a further object, feature, or advantage to assist paralyzed individuals In participating in the activities of life through recognition of control patterns based on facial EMG presets.

It is a still further object, feature, or advantage to allow a user to select EMG control settings in lieu of, or in addition to other control inputs including gesture based controls via accelerometer macros.

Another object, feature, or advantage is to provide greater precision in fine tuning the control functions of a device.

Yet another object, feature, or advantage is the transmission of EMG functional data to receptor devices. This allows the receptor device or devices to better respond to the inputs/commands of the user.

A further object, feature, or advantage is to provide bio-medical monitoring of the user through the use of sensor array systems.

A still further object, feature, or advantage is to augment accelerometer based solutions for control of macros.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any object, features or advantage stated herein.

According to one aspect a system includes at least one wearable device, wherein each wearable device includes a processor, a gesture control interface operatively connected to the processor, at least one sensor configured to detect electrical activity from a user’s facial muscles, the at least one sensor operatively connected to the processor, and wherein the processor is configured to interpret the electrical activity from the user’s facial muscles as a first command to perform action according to a pre-determined user setting. The at least one sensor may be an electromyogram (EMG) sensor. Each wearable device may further include a transceiver operatively connected to the processor. The at least one wearable device may include a set of earpieces comprising a first earpiece and a second earpiece. The first earpiece may further include at least one microphone operatively connected to the processor and at least one speaker operatively connected to the processor. The first earpiece may be further configured not to interpret the electrical activity from the user’s facial muscles as a command if the user is talking as determined using the at least one microphone. The first earpiece may further include an inertial sensor operatively connected to the processor and wherein the processor is configured to interpret the electrical activity from the user’s facial muscles in combination with at least one of head orientation or movement as a second command. The at least one wearable device may include a set of earphones. The system may further include a software application executing on a mobile device configured to provide for modifying the pre-determined user setting.

According to another aspect, a method for using facial muscle electromyogram (EMG) potential as input may include providing at least one wearable device, wherein each wearable device includes a processor, a gesture control interface operatively connected to the processor, at least one EMG sensor configured to detect electrical activity from a user’s facial muscles, the at least one EMG sensor operatively connected to the processor. The is configured to interpret the electrical activity from the user’s facial muscles as a first command to perform an action according to a pre-determined user setting. The method may further include receiving the facial muscle EMG potentials at the at least one EMG sensor and interpreting at the processor the facial muscle EMG potentials as a first command to perform the action according to a pre-determined user setting.

### BRIEF DESCRIPTION OF THE DRAWINGS

FIG. 1 includes a block diagram of one embodiment of the system.

FIG. 2 illustrates a block diagram of a second embodiment of the system.

FIG. 3 illustrates a set of wireless earpieces in communication with a mobile device executing a software application.

FIG. 4 illustrates one example of an earpiece seated in an ear.

FIG. 5 illustrates a portion of an earphone with a plurality of EMG sensors.

### DETAILED DESCRIPTION

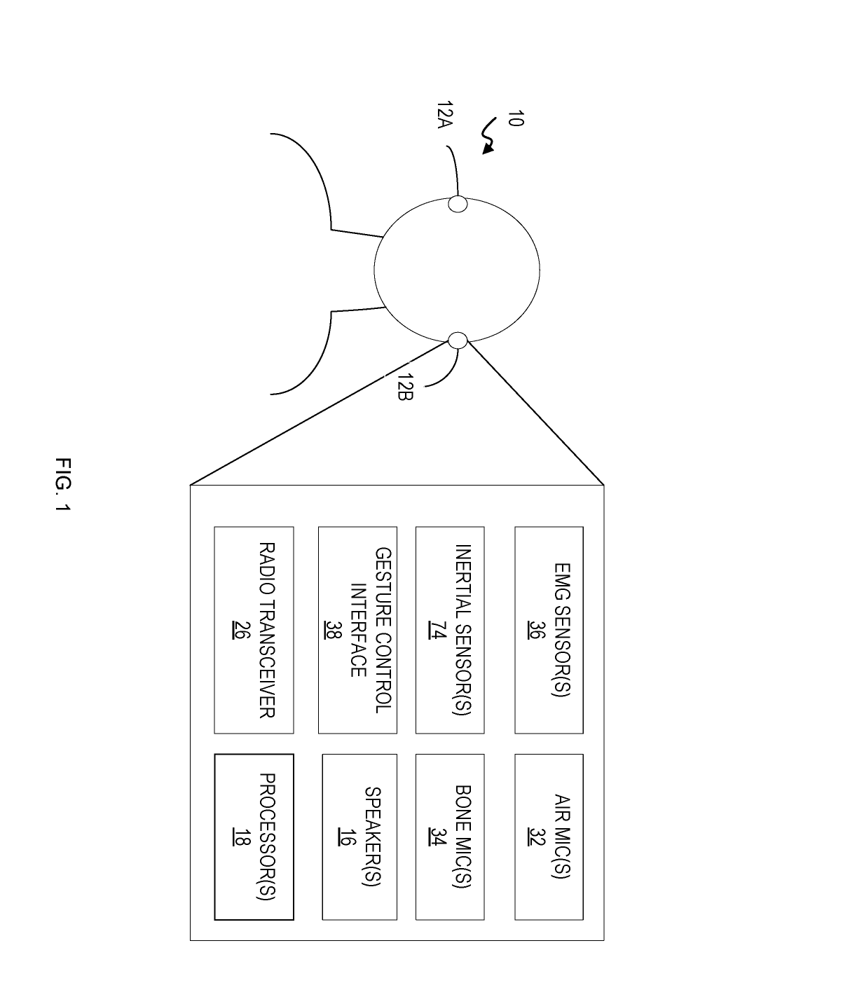

FIG. 1 illustrates one example of a wearable device in the form of a set of wireless earpieces 10 which includes a right earpiece 12A and a left earpiece 12B. The set of wireless earpieces are configured to detect muscle contractions such as through use of one or more EMG sensors 36. The one or more EMG sensors 36 may contact one or more muscles to detect muscle contractions. For example, changes such as tightening or loosening of the jaw by the associated muscles may be detected. The placement of the one or more EMG sensors 36 determines which muscle contractions may be sensed. The muscle contractions may be deliberate by a user with the user making the muscle contractions for the purpose of providing input into the wearable device.

The EMG sensors 36 may be combined with additional forms of user input. This may include one or more inertial sensors 74, a gesture control interface 38, one or more air microphones 32, and one or more bone microphones 34. The one or more inertial sensors 74 may include a 9-axis inertial sensor which includes a 3-axis accelerometer, a 3-axis gyrometer, and a 3-axis compass.

The wireless earpiece 12B may also include a radio transceiver 26 such as a BLE, BLUETOOTH, Wi-Fi, or other type of radio transceiver, one or more speakers 16, and one or more processors 18. The one or more processors 18 may be operatively connected to the other components including the one or more EMG sensors 36, the one or more air microphones 32, the inertial sensor 74, the one or more bone microphones 34, the gesture control interface 38, the one or more speakers 16, and the radio transceiver 38.

Where one or more bone conduction microphones 34 and/or one or more air microphones 32 are present, signals from the microphones 34, 32 may be used to determine when certain muscle movement detected with the EMG sensors 36 is associated with speech of the user and when it is not. Thus, for example, when speaking a user would be moving their mouth which requires engaging a number of different muscles. The wireless earpiece may associate the readings from the one or more EMG sensors 36 with speech and thus not consider input received through the EMG sensors 36 to be user input to perform particular actions.

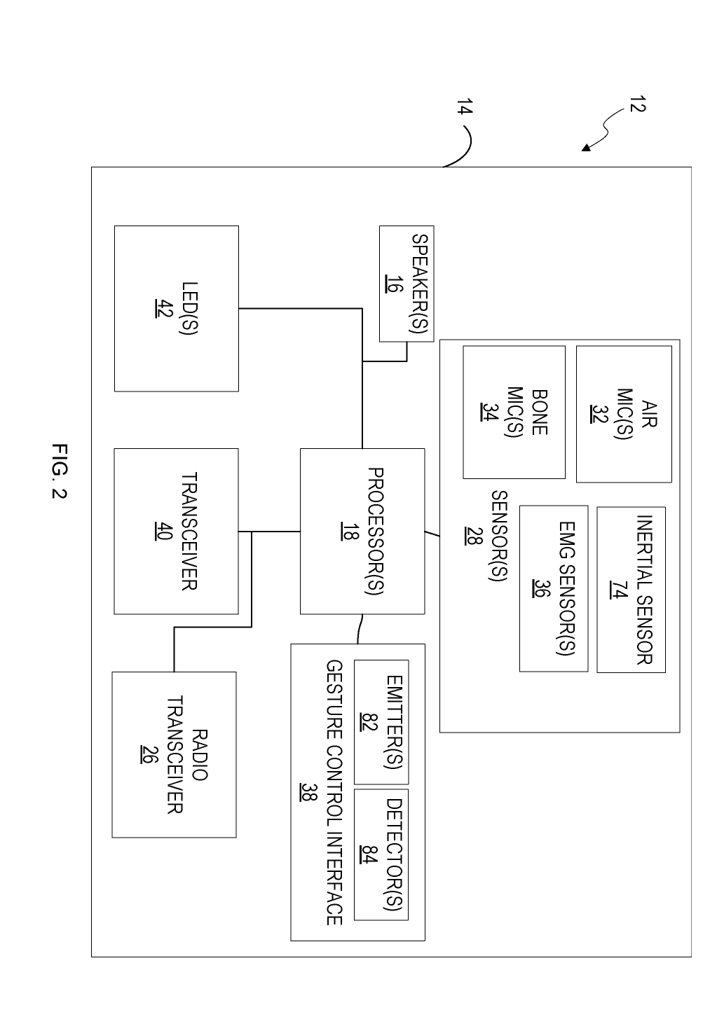

FIG. 2 is a block diagram further illustrating one example of an earpiece 12. The earpiece 12 has a housing 14. Disposed within the housing 14 is one or more processors 18 which may include microprocessors, digital signal processors, mixed signal processors, or other types of processors. The processor 18 is operatively connected to a plurality of sensors 28. The plurality of sensors 28 may include one or more air microphones 32, one or more bone microphones 34, one or more inertial sensors 74, and one or more EMG sensors 76. One or more speakers 16 are also operatively connected to the processor 18. One or more LEDs may be operatively connected to the processor to display status or other purposes. A radio transceiver 26 is operatively connected to the processor and a transceiver 40 may also be operatively connected to the processor 18. The transceiver 40 may be a near field magnetic induction (NFMI) transceiver or other type of transceiver. In some embodiments, the transceiver 40 may be used to communicate between a left earpiece and a right earpiece. In such an embodiment, only one earpiece 12 within a set of earpieces would need to have a radio transceiver 26. The gesture control interface 38 is also operative connected to the one or more processors 18. The gesture control interface 38 may include one or more emitters 82 and one or more detectors 84 to emit and detect an energy field. For example, the one or more emitters 82 may emit light and the one or more detectors 84 may detect reflected light. A user may perform gestures proximate the gesture control interface 30 in order to provide user input. For example, a user may perform one or more taps, holds, swipes, or other gestures to provide user input. Other technologies may be used to emit and detect other types of energy field.

It is also to be understood that in order to provide user input, a user may combine one more gestures as determined by the gesture control interface 38 with one or more facial expressions as determined by the one or more EMG sensors 76 in addition to one or more head movements or head orientations as determined by the one or more inertial sensors 74. Thus, complex input from a user may be quickly communicated using a combination of modalities and in a manner that may be more private than providing voice commands.

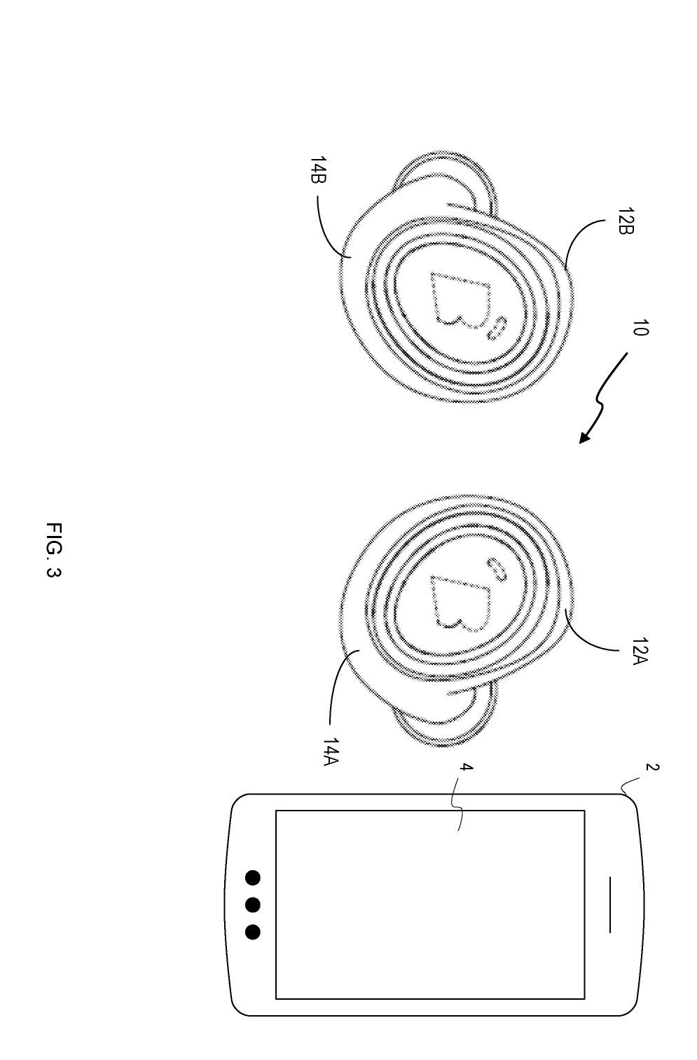

FIG. 3 illustrates one example of a set of wireless earpieces 10 which includes a first earpiece 12A and a second earpiece 12B, the first earpiece 12A having a first earpiece housing 14A and the second earpiece 12B having a second earpiece housing 14B. A receptor device such as a mobile device 2 such as a mobile phone is also shown. The mobile device 2 includes a display 4. A software application may execute on a processor of the mobile device 2 for controlling settings associated with the set of wireless earpieces 10. The settings may allow for a user to map different muscle movement or different facial expressions or gestures to different actions. The facial gesture may be a wink, a wince, a smile, one or more blinks, or any facial expression a user is capable of making, and need not be limited to a single gesture. It should also be understood that the gesture or associated muscle contractions being detected may be on the user’s face or neck. The electrical reading may be from anywhere on the user’s face or neck and need not be performed in a single step. For example, a series of muscle contractions may be indicative of a particular gesture, or a combination of different muscle contractions may be indicative of a particular gesture. One or more processors then interprets the facial muscular electrical data to determine a user response. The wearable device may then perform an action based on the user response.

It is also to be understood that instead of performing processing of EMG sensor data on one or more of the earpieces, this data may be communicated such as over a wireless communication linkage such as a BLE or BLUETOOTH connection to the mobile device 2. The mobile device 2 may then perform processing and return results to the set of wireless earpieces 10. Alternatively, the mobile device 2 may communicate the sensor data over a network to a remote location such as to a cloud computing service which may analyze the data and return the results of the analysis to the mobile device 2 and then in turn to the set of wireless earpieces 10 if so desired. It is also contemplated that the same data may be analyzed in multiple locations and that different types of analysis may occur depending on the location. For example, the most computationally intensive forms of analyses may be performed at a remote location with greater computation resources than present in the set of wireless earpieces 10.

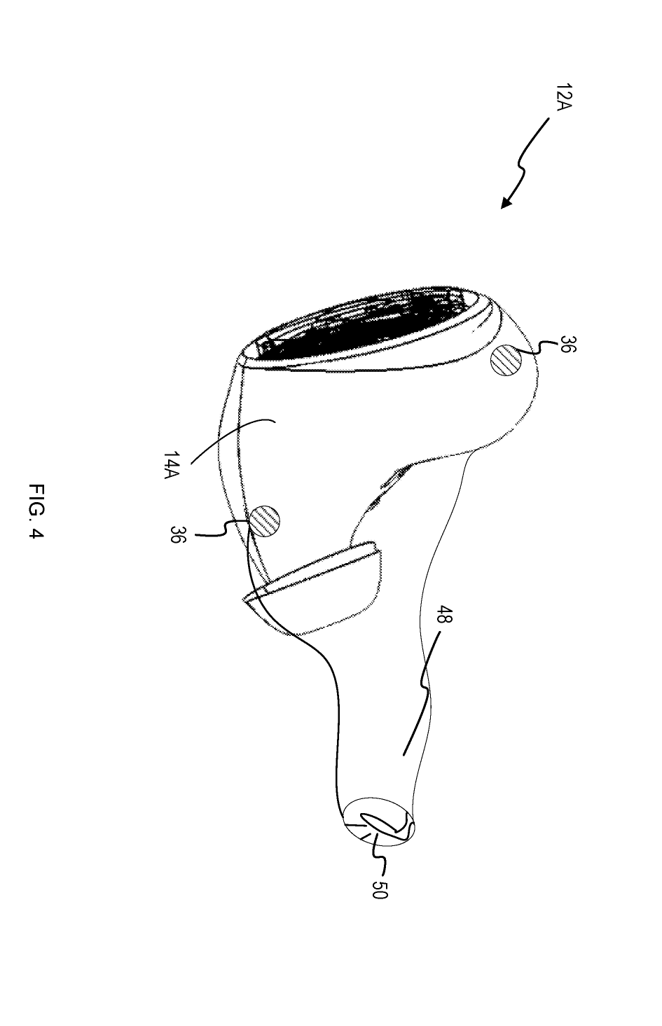

FIG. 4 illustrates the earpiece 12A inserted into an ear of a user and illustrates an external auditory canal 48 and tympanic membrane 40. One or more EMG sensors 36 may be placed at an external surface of the earpiece housing 14A so as to contact a skin surface of the user in order to detect electrical activity associated with muscle movement. Although particular positions are shown, it is to be understood that any number of other positions may be used as may be appropriate depending upon the muscles to be monitored and the size, shape, and configuration of the ear piece or other wearable device.

Because a human is able to control the muscles of facial expression to impressive degrees, the precise control allows the user to transfer nuances of the human emotion spectrum. Such slight movement of the muscles of facial expression can be monitored, and their activity harnessed. Additionally, larger muscles of the head and neck may be able to be activated in order to provide other levels of biometric EMG control inputs to the device. These device inputs may also be preset such as via a software application executing on a mobile device. Thus, user settings may be modified using the software application. Any number of actions may be performed as determined by a user. This may, for example, include actions to initiate a phone call to a particular person or place, listen to a particular song or other audio selection, begin an activity, or any number of other actions which the wearable device may perform.

Biometric data from the EMG sensors may also be relayed to receptor devices without the need or requirement for EMG controls. The array of biometric EMG sensors may be used to better understand the emotional and physiologic status of the user. Such data may be used predictively as well as eliciting a pre-programmed response. In particular, instead of relying upon pre-determined user settings to associate facial expressions with specific commands, the facial expressions may be used to predict user actions or user needs. For example, where voice feedback is being provided to a user of an earpiece presenting options to a user and a user winces in response to an option, the facial expression may be interpreted as a “no”.

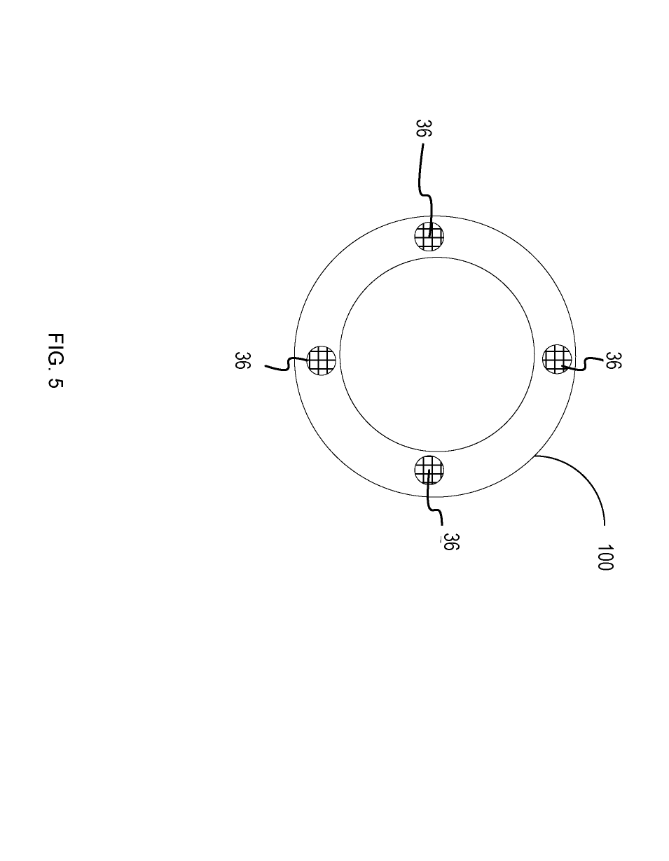

FIG. 5 illustrates an inside portion of an ear cup housing of a set of earphones. A plurality of EMG sensors 36 are positioned around the ear cup housing and may be used to sense muscle activity. More or fewer EMG sensors 36 may be present and the EMG sensors may be of varying sizes and shapes. It is to be understood that the EMG sensors may be associated with other types of wearable devices as well.

Although various methods, systems, and apparatuses have been shown and described herein, the present invention contemplates any number of options, variations, and alternative embodiments. For example, it is contemplated that the wearable device may be of any number of types of devices and any number of different facial gestures may be recognized.

What is claimed is:

1. A method of operating a wearable device, the wearable device comprising a housing, at least one electromyogram (EMG) sensor disposed at an external surface of the housing, an inertial sensor, at least one microphone, at least one speaker, and a processor operatively connected to the at least one EMG sensor, the inertial sensor, the at least one microphone, and the at least one speaker, the method comprising:
generating, by the at least one speaker, voice feedback presenting two or more options to a user;
receiving, at the at least one EMG sensor in response to the voice feedback, a first signal indicative of electrical activity from a facial muscle of the user;
receiving, at the inertial sensor in response to the voice feedback, a second signal indicative of at least one of head orientation and head movement of the user;
receiving, at the at least one microphone in response to the voice feedback, a third signal comprising audio input;
determining, by the processor and based at least in part on the third signal, whether the user is talking; and
identifying, by the processor, one of the two or more options as selected by the user based on the first signal in combination with the second signal, wherein the identifying is performed in response to the determining indicating that the user is not talking, and wherein the identifying is not based on a stored association between any particular facial-muscle signal and any particular command, but is instead based on the first signal and the second signal in the context of the two or more options presented by the voice feedback.

2. The method of claim 1, wherein the wearable device is a first earpiece comprising the housing, and wherein the method further comprises receiving, at a second EMG sensor disposed at an external surface of a second earpiece in wireless communication with the first earpiece, a fourth signal indicative of electrical activity from a facial muscle of the user, the identifying being further based on the fourth signal.

3. The method of claim 1, wherein the at least one EMG sensor is configured to detect a tightening or loosening of a jaw muscle of the user, and wherein the first signal is indicative of the tightening or loosening of the jaw muscle.

4. The method of claim 1, wherein the first signal is indicative of electrical activity from a facial muscle associated with a facial expression of the user other than a wink, a wince, a smile, or a blink.

5. The method of claim 1, wherein the first signal comprises a series of muscle contractions of the facial muscle, and wherein the identifying further comprises determining a pattern of the series of muscle contractions and selecting the one of the two or more options as a function of the pattern.

6. The method of claim 1, wherein the second signal is indicative of a head movement of the user, and the identifying further comprises selecting the one of the two or more options as a function of a direction of the head movement in combination with the first signal.

7. The method of claim 1, wherein one of the two or more options corresponds to a negative response to the voice feedback, the first signal is indicative of a wince of the user, and the identifying further comprises selecting the option corresponding to the negative response based at least in part on the first signal being indicative of the wince.

8. The method of claim 1, wherein the inertial sensor comprises a 9-axis inertial sensor having a 3-axis accelerometer, a 3-axis gyrometer, and a 3-axis compass.

9. A system comprising:
a wearable device comprising a housing, at least one electromyogram (EMG) sensor disposed at an external surface of the housing, an inertial sensor disposed within the housing, at least one microphone, at least one speaker, a first processor operatively connected to the at least one EMG sensor, the inertial sensor, the at least one microphone, and the at least one speaker, and a wireless transceiver operatively connected to the first processor;
a mobile device in wireless communication with the wearable device through the wireless transceiver, the mobile device comprising a second processor and a network interface; and
a remote computing resource in network communication with the mobile device through the network interface;
wherein the first processor is configured to perform a first analysis on sensor data including an EMG signal from the at least one EMG sensor and an inertial signal from the inertial sensor, and to transmit, through the wireless transceiver to the mobile device, at least a portion of the sensor data;
wherein the second processor is configured to perform a second analysis on the at least a portion of the sensor data and to transmit, through the network interface to the remote computing resource, at least a subset of the sensor data;
wherein the remote computing resource is configured to perform a third analysis on the at least a subset of the sensor data and to return, through the network interface, a result of the third analysis to the mobile device;
wherein the mobile device is configured to forward at least a portion of the result of the third analysis through the wireless transceiver to the wearable device;
wherein the wearable device is configured to produce, at the at least one speaker, an audible output based at least in part on the portion of the result of the third analysis; and
wherein the third analysis is of greater computational complexity than the first analysis.

10. The system of claim 9, wherein the first processor is further configured to determine, based at least in part on a signal from the at least one microphone, whether the user is talking, and to refrain from interpreting the EMG signal as a command when the user is determined to be talking.

11. The system of claim 9, wherein the result of the third analysis is indicative of an emotional or physiological status of the user, and wherein the audible output produced at the at least one speaker is based at least in part on the emotional or physiological status of the user.

12. The system of claim 9, wherein the wearable device is a first earpiece, the system further comprising a second earpiece in wireless communication with the first earpiece and comprising at least one speaker, and wherein the audible output is produced at one or both of the at least one speaker of the first earpiece and the at least one speaker of the second earpiece.

13. A method of operating a wearable device, the wearable device comprising a housing, at least one electromyogram (EMG) sensor disposed at an external surface of the housing, an inertial sensor, at least one microphone, at least one speaker, a processor operatively connected to the at least one EMG sensor, the inertial sensor, the at least one microphone, and the at least one speaker, and a wireless transceiver operatively connected to the processor, the method comprising:
generating, by the at least one speaker, voice feedback presenting two or more options to a user, wherein at least one of the two or more options corresponds to one of (i) initiating a telephone call to a person or place and (ii) playing an audio selection at the at least one speaker;
receiving, at the at least one EMG sensor in response to the voice feedback, a facial-muscle signal indicative of electrical activity from a facial muscle of the user;
receiving, at the inertial sensor in response to the voice feedback, an inertial signal indicative of at least one of head orientation and head movement of the user;
receiving, at the at least one microphone in response to the voice feedback, an audio input signal;
determining, by the processor and based at least in part on the audio input signal, whether the user is talking;
determining, by the processor and in response to determining that the user is not talking, a selection by the user of one of the two or more options based at least in part on the facial-muscle signal in combination with the inertial signal;
when the determined selection corresponds to initiating the telephone call, transmitting, through the wireless transceiver to an external device, a command to initiate the telephone call to the person or place; and
when the determined selection corresponds to playing the audio selection, causing the at least one speaker to initiate playback of the audio selection.

14. The method of claim 13, wherein the two or more options further comprise an option corresponding to a negative response to the voice feedback, the facial-muscle signal is indicative of a wince of the user, and the determining of the selection comprises selecting the option corresponding to the negative response based at least in part on the facial-muscle signal being indicative of the wince.

15. The method of claim 13, wherein the facial-muscle signal is indicative of a tightening or loosening of a jaw muscle of the user, and the determining of the selection is based at least in part on the tightening or loosening of the jaw muscle.

16. The method of claim 13, wherein the audio selection comprises a song.

17. The method of claim 13, wherein the external device is a mobile telephone, and the command to initiate the telephone call is transmitted through the wireless transceiver to the mobile telephone.
